(19) United States
(12) Patent Application Publication
(10) Pub. No.: US 2015/0345732 A1
(43) Pub. Date: Dec. 3, 2015

(54) REFINED LAMPSHADE STRUCTURE

(71) Applicant: SU-FANG HO, NEW TAIPEI CITY (TW)

(72) Inventor: SU-FANG HO, NEW TAIPEI CITY (TW)

(21) Appl. No.: 14/294,274

(22) Filed: Jun. 3, 2014

(51) Int. Cl. F21V 1/00; F21V 29/50

(52) U.S. Cl. CPC F21V 1/00; F21V 29/50; F21Y 2101/02

(57) ABSTRACT

A refined lampshade structure includes a supporting stand, a bulb holder, a lampshade covering the bulb holder, which has a hollow extension tube with a threaded section arranged on top edge thereof, a LED lighting module engaging with an opening on the top of the extension tube, and a light transmissive protection shell fixed on the threaded section. The light transmissive protection shell integrates the LED lighting module with the bulb holder by fixing the lampshade on the extension tube. With lampshade being easily disassembled for cleaning or replacing, the present invention features enhanced practicability and durability.

### BACKGROUND OF THE INVENTION

1. Field of the Invention

The present invention relates to a refined lampshade structure, particularly to one that has a LED bulb arranged above the lampshade. The lampshade is easily disassembled, enabling the users to clean or replace it at their will.

2. Description of the Related Art

As shown in FIG. 1, the table lamp assembly is comprised of several basic components. They are: a lamp support column to which is attached a lamp harp assembly, and a typical lampshade, setting atop the harp and held in place by the final, a modular replaceable plug-in electronic ballast and a modular adapter containing the ballast receptacle. While a circular fluorescent lamp is shown, this plug-in electronic ballast can be used with fluorescent lamps of any shape, e.g. light bulb. Secured to the top of lamp column is the lower portion of the lamp harp. A decorative final, when screwed down, maintains the placement of the lampshade in its desired position; thereby preventing the lampshade from tipping unevenly to one side and also preventing it from rotating undesirably should one inadvertently brush against it. This structure is from the U.S. Pat. No. 6,390,646, but such table lamp assembly does not have function of night light.

Traditional table lamp assembly provides lighting on desks and has been developed into different lighting fixtures in bedrooms, especially hotel rooms, and become the main fittings functioning lighting and decorations. Such lamps usually have a switch to adapt for different purposes as normal lighting and dim lights at sleep. However, the lamp designs are simple and lack of variety, as in FIG. 1, unable to make visual effects to the consumers. Plus, applications of LED bulbs are getting wider and more advanced in recent years. Colorfulness and various designs are two of the welcoming features. Lighting a LED nigh light at night in the bedroom creates soft lighting and the various designs make it even more decorative.

Therefore, it is desirable for the inventor to combine the traditional lamps with LED bulbs to create an integrated lamp fixture with various designs of lampshades that can be easily disassembled without affecting the main structure.

### SUMMARY OF THE INVENTION

The primary object of the present invention is to provide an electricity-saving night light with soft lights by combining traditional lamp structure with LED bulbs.

Another object of the present invention is to provide an innovative lampshade structure which is easily disassembled to enhance the practicability and durability.

In order to achieve the objects above, the present invention comprises a hollow supporting stand disposed on a base, a bulb holder disposed on the supporting stand with at least one light bulb thereon connecting to a first electric wire, a lampshade including a frame and a circular cover covering the bulb holder wherein the bulb holder has a hollow extension tube with a threaded section arranged on top edge thereof, forming a positioning surface, a LED lighting module engaging with an opening on the top of the extension tube and connecting to a second electric wire from the bottom, a positioning portion disposed at the center of the frame which has an axial hole that can be engaged on the threaded section to fit in the positioning portion and positioning surface, and a light transmissive protection shell with inside threads at the bottom corresponding to the threaded section to fix it on; whereby the light transmissive protection shell integrates the LED lighting module with the bulb holder by fixing the lampshade on the extension tube; or it could be disassembled in reverse order to displace the lampshade.

Furthermore, the LED lighting module includes a LED bulb electrically connected to a resistive circuit board that connects to the second electric wire, and a water-proof sheath wrapping up the LED bulb and resistive circuit board, arranged in-between the LED lighting module and the extension tube to fix the structure.

Besides, the light tramissive protection shell has a flat bottom at the center with a locking portion bulging up and the inside threads at central thereof, and a cooling opening arranged at the top of the light transmissive protection shell.

With features disclosed above, the bulb holder and light bulb(s) are arranged in the middle section of the supporting stand and at the top of the extension tube a LED bulb is arranged. Two electric wires go through the hollow supporting stand and extension tube to link up each bulb, thus enhance the effectiveness of the invention. In addition, the positioning portion on the lampshade fits the threaded section, and the entire lamp structure is fixed by screwing the light transmissive protection shell tight, without touching or moving the LED bulb or electric wires. The practicability and durability of the present invention are therefore improved.

### BRIEF DESCRIPTION OF THE DRAWINGS

FIG. 1 is a perspective view of a lamp according to the prior art;

FIG. 2 is an exploded view of a preferred embodiment of the present invention;

FIG. 3 is an exploded view of the present invention with assembled LED lighting module;

FIG. 4 is an exploded view of the present invention with assembled LED lighting module engaging into the extension tube;

FIG. 5 is a perspective view of a preferred embodiment of the present invention;

FIG. 6 is a cross-section view of a preferred embodiment of the present invention;

FIG. 6A is a cross-section view of the LED lighting module of a preferred embodiment of the present invention;

FIG. 7 is a practical application view of the present invention with base arrangement of standing vase style and an erect extension tube;

FIG. 8 is a practical application view of the present invention with base arrangement of standing vase style and a curved extension tube;

FIG. 9 is another practical application view of the present invention with base arrangement of standing vase style and a curved extension tube;

FIG. 10 is a practical application view of the present invention with base arrangement of plate style and an A-shaped supporting stand; and

FIG. 11 is another practical application view of the present invention with base arrangement of inverted T-shaped style and a curved supporting stand.

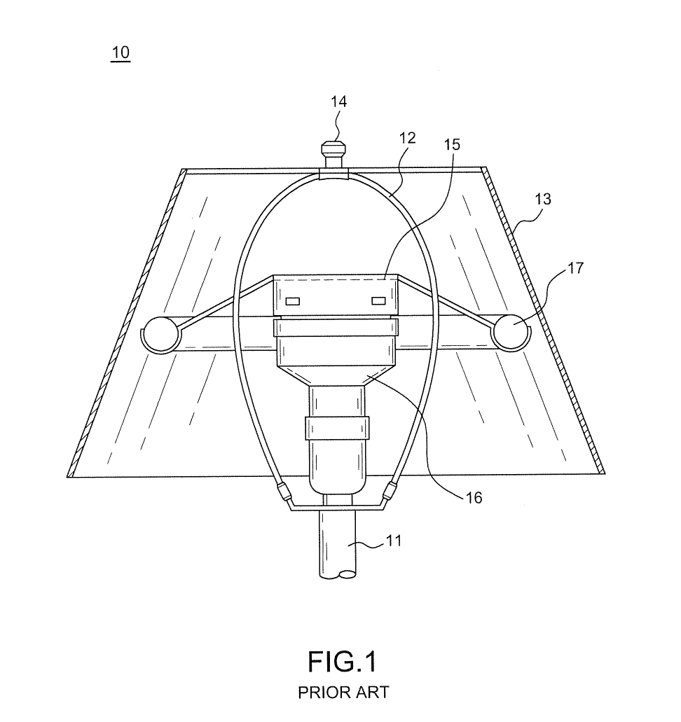

### DETAILED DESCRIPTION OF THE PREFERRED EMBODIMENT

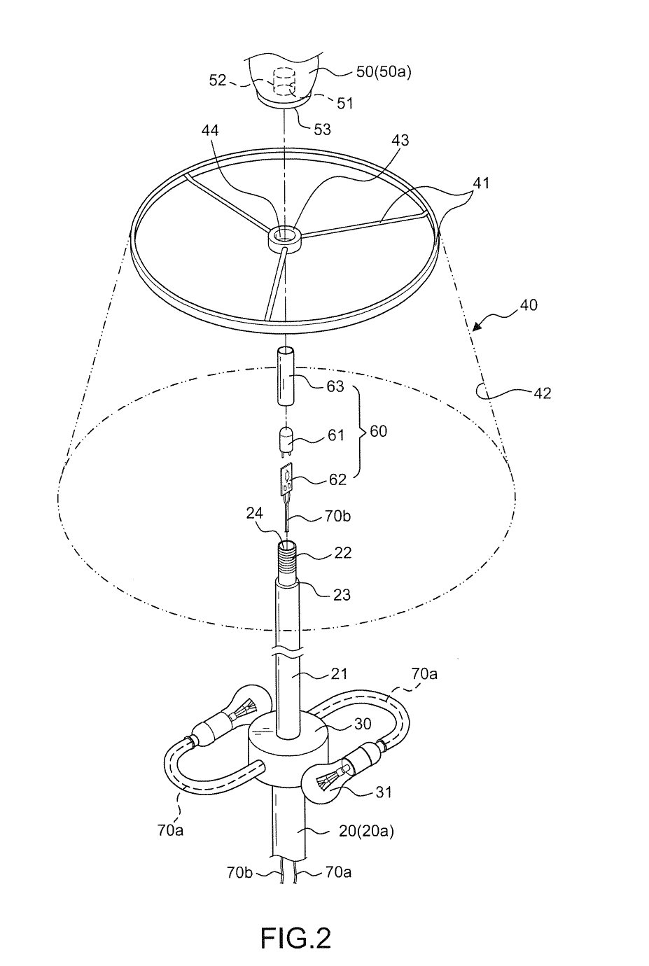

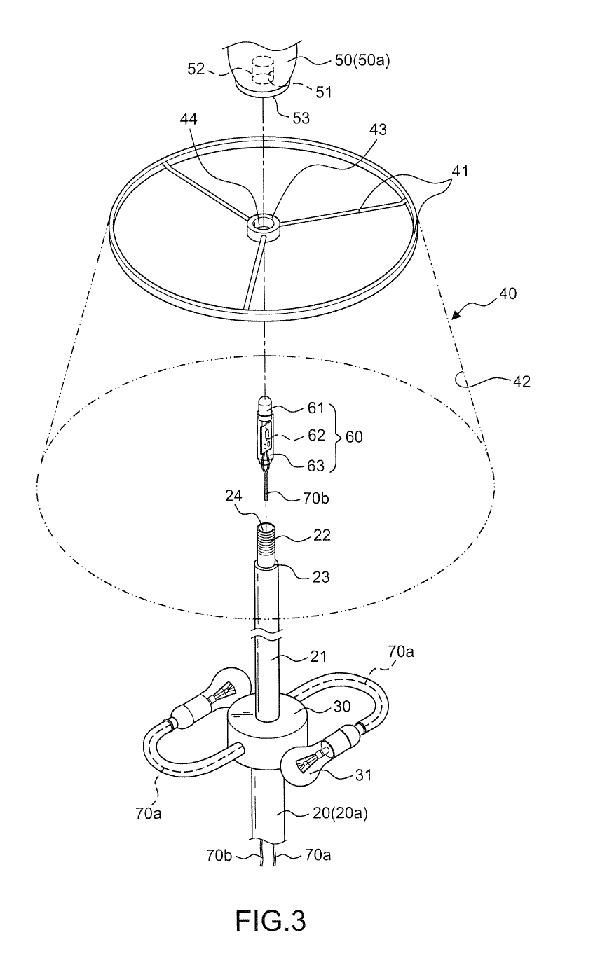

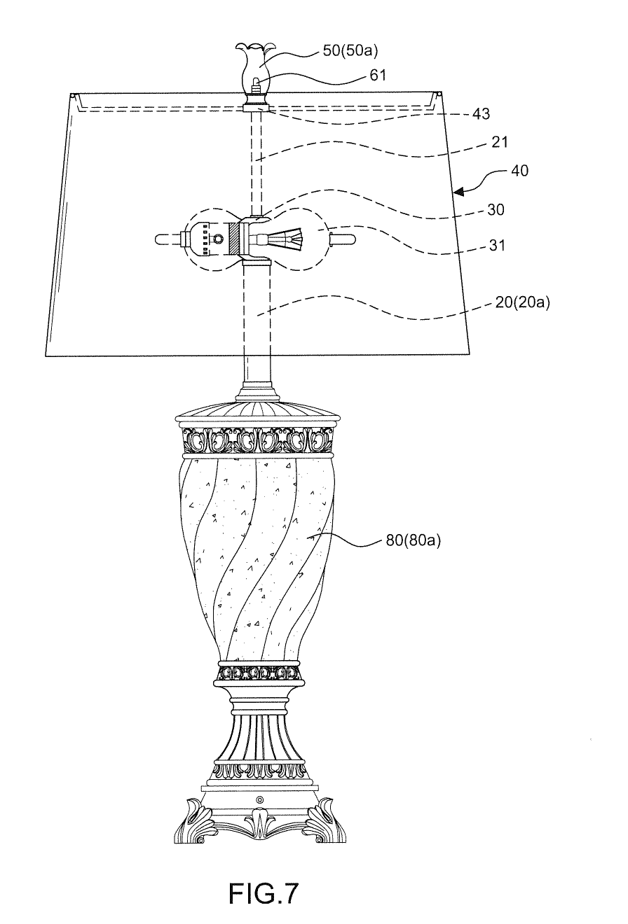

Referring to FIGS. 2-7, a preferred embodiment of the present invention includes a supporting stand 20 which is hollow and disposed on a base 80, a bulb holder 30 disposed on said supporting stand 20 with at least one light bulb 31 thereon connecting to a first electric wire 70a, and a lampshade 40 including a frame 41 and a circular cover 42, covering said bulb holder 30;

wherein the bulb holder 30 has a hollow extension tube 21 with a threaded section 22 arranged on top edge thereof, forming a positioning surface 23, and a

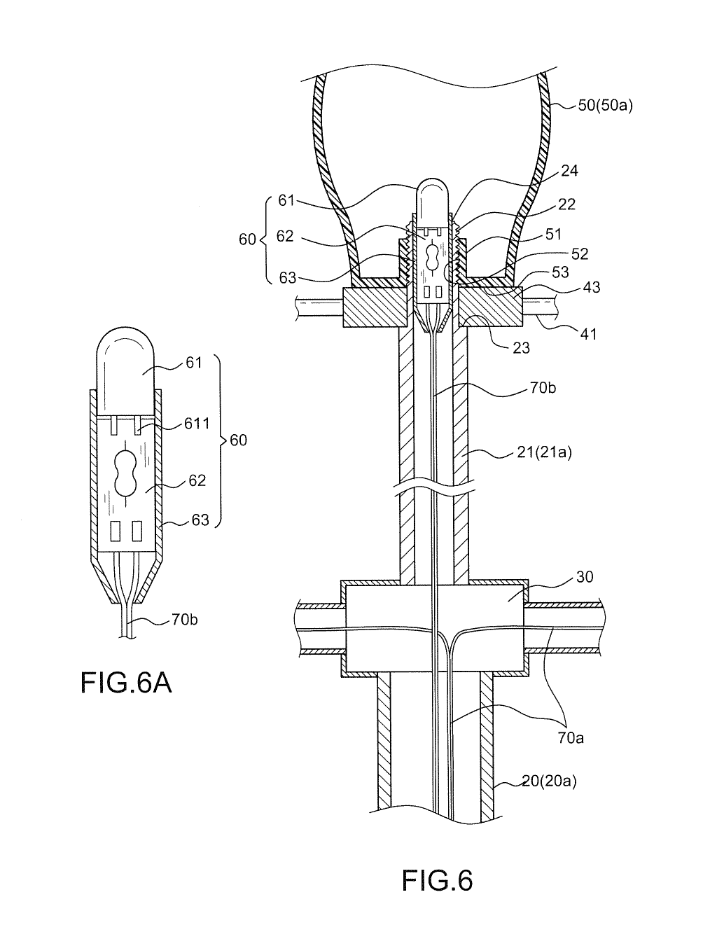

LED lighting module 60 engages with an opening 24 on the top of said extension tube 21 and connecting to a second electric wire 70b from the bottom. In this embodiment, the LED lighting module 60 includes a LED bulb 61 electrically connected to a resistive circuit board 62 that connects to said second electric wire 70b, and a water-proof sheath 63 wrapping up said LED bulb 61 and resistive circuit board 62, arranged in-between the LED lighting module 60 and the extension tube 21 to fix the structure, either with or without usage of adhesive; the resistive circuit board here refers to a circuit board with a resistor set in the loop. With reference to FIG. 6A, the LED lighting module 60 has the LED bulb 61 and resistive circuit board 62 assembled together, featuring the present invention as prolonged durability since the terminal 611 of the LED bulb 61 links up to the resistive circuit board 62 and is not easily damaged; plus the resistor on the circuit board can stable the electric currents. And the water-proof sheath 63 can be either a plastic sheath or wrapping to prevent the module from damp and to engage into the opening 24 of the extension tube 21. Besides, the engagement can be firmer with adhesive around the opening 24 but this is optional. By means of aforesaid structure, the LED lighting module 60 is stably fixed on the extension tube 21 and further functions as a night light.

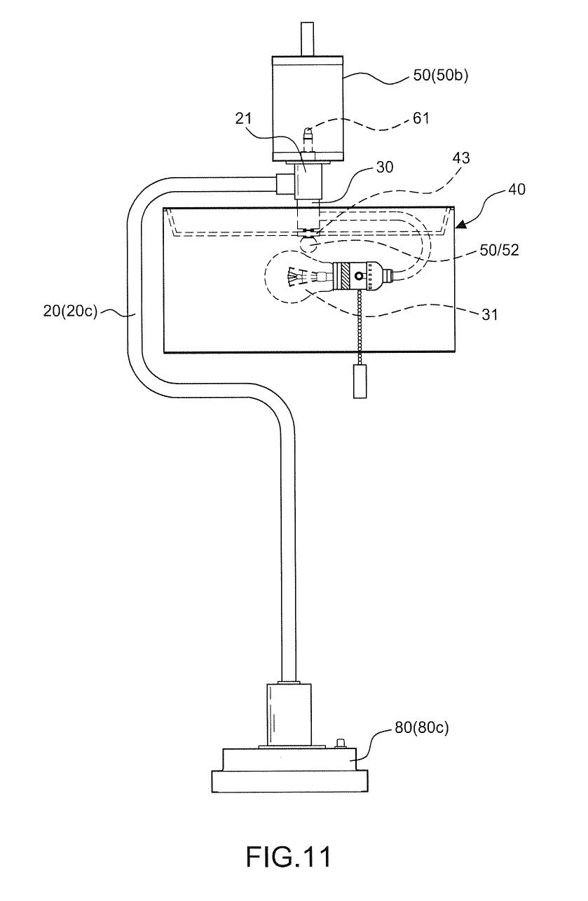

Moreover, a positioning portion 43 is disposed at the center of said frame 41 which has an axial hole 44 that can be engaged on said threaded section 22 to fit said positioning portion 43 and positioning surface 23, and a light transmissive protection shell 50 with inside threads 51 at the bottom is corresponding to said threaded section 22 to fix it on. In this embodiment, the light tramissive protection shell 50 has a flat bottom 52 at the center with a locking portion 53 bulging up and the inside threads 51 at central thereof, and a cooling opening 54 is arranged at the top of said light transmissive protection shell 50. The light transmissive protection shell 50 can be a thick tube-shaped object as shown in FIG. 11 as well;

whereby the light transmissive protection shell 50 integrates said LED lighting module 60 with said bulb holder 30 by fixing said lampshade 40 on the extension tube 21; or it could be disassembled in reverse order to displace said lampshade 40.

In this embodiment, the first electric wire 70a and second electric wire 70b are arranged inside the hollow supporting stand 20, connecting to the power supply at the bottom. The first electric wire 70a electrically connects to the bulb holder 30 at the top, supplying the electricity for the light bulb 31; and the second electric wire 70b goes through the bulb holder 30 and the extension tube 21, supplying electricity for the LED bulb 61. Further, in order to switch between the bulb holder 30 and the LED bulb 61, the present invention has a transformer and a multistage switch (not shown in the FIGS.) linking to the first and second electric wires 70a, 70b. The transformer and multistage switch are preferable to be disposed inside the base 80.

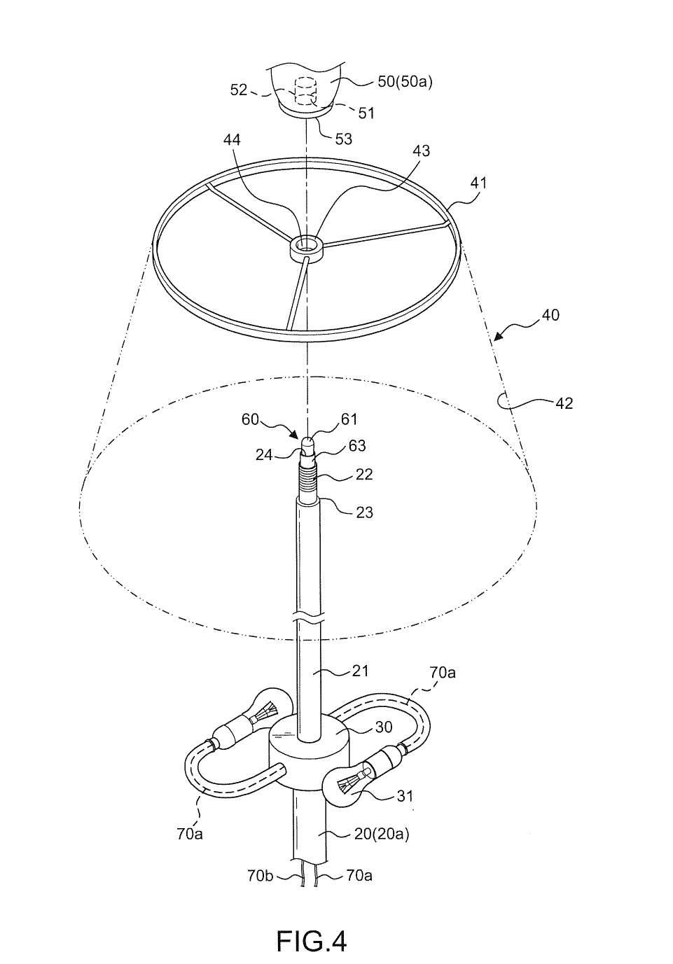

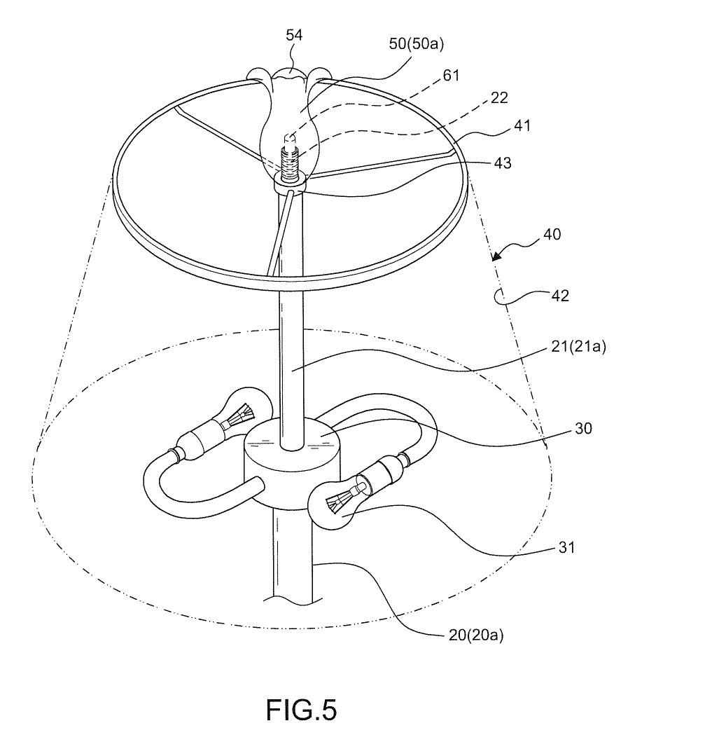

FIGS. 4 and 5 are illustrations of the lampshade assembly. Firstly, put the positioning portion 43 around the threaded section 22 to fit the positioning surface 23. Then screw the light transmissive protection shell 50 down to the threaded section 22 to join the positioning surface 43. The lampshade 40 is therefore fixed on the extension tube 21 as shown in FIG. 6. It can also be disassembled by reversing the aforesaid steps.

The assembling and disassembling process of the lampshade 40 does not require touching or moving the LED bulb 61 or any other electric components such as electric wires. Plus, the delivery of the present invention is easier since the lampshade 40 and its related components can be separately delivered from the framework of the lamp, reducing the volume of the packages. Also, the consumers can make their own choices upon the models of the lampshade. What's more, the lampshade 40 may need to be disassembled for cleaning due to dirt or other factors. The feature mentioned above further enhances the practicability and durability of the present invention.

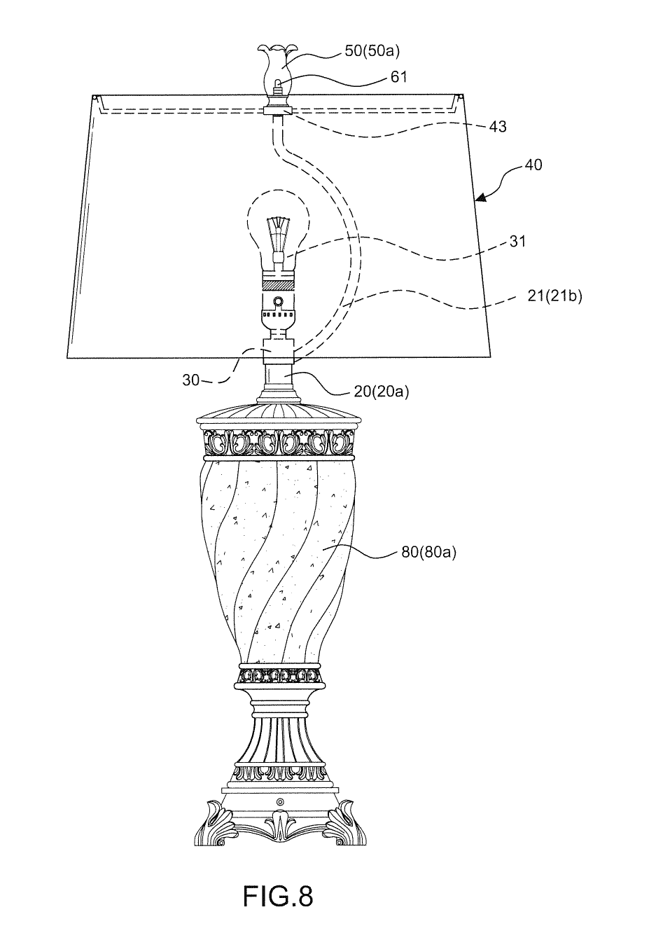

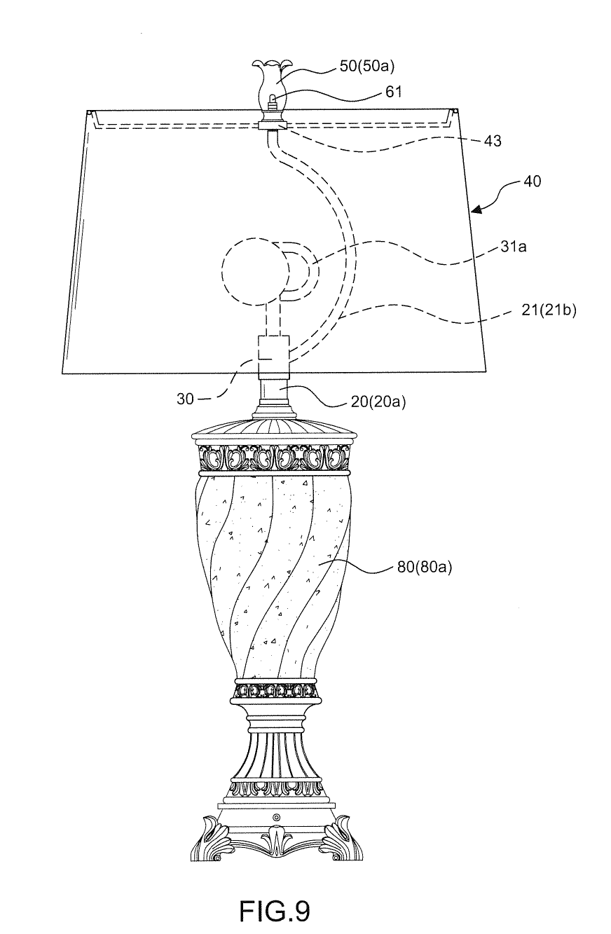

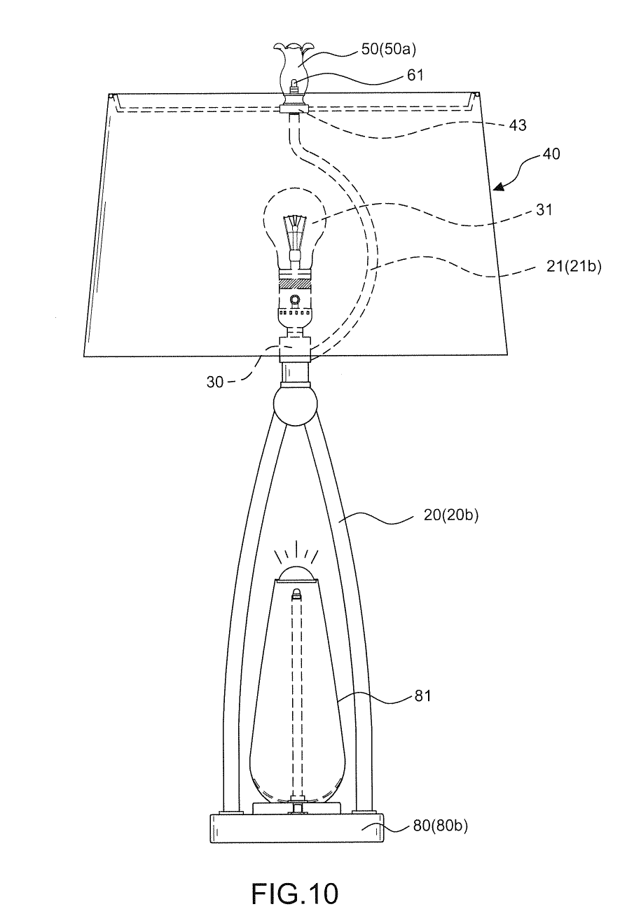

In this embodiment, the base 80 is arranged as standing vase style 80a, and the supporting stand 20 and the extension tube 21 are erectile 20a, 21a, but the present invention is not limited to such application. For example, as shown in FIG. 8, the extension tube 21 is a curved tube 21b. Or as shown in FIG. 10, the base 80 is arranged as plate style 80b with an A-shaped supporting stand 20b and curved extension tube 21b; on the plate style base 80 there is a decorative fixture 81 disposed. In FIG. 11, the base 80 is in inverted T-shaped style 80c and the supporting stand 20 is curved 20c. The light bulb 31 includes tungsten bulb or Bakelite bulb 31a as in FIG. 9, and can be arranged either horizontal or vertical.

With aforesaid structures and measures, the present invention integrates the structures of traditional lamps and LED bulbs as the bulb holder 30 and light bulb(s) 31 arranged in the middle section of the supporting stand 20; at the top of the extension tube 21 a LED bulb 61 is arranged; two electric wires 70a, 70b go through the hollow supporting stand 20 and extension tube 21 to link up each bulb so as to switch the lights. Besides, the present invention has the positioning portion 43 to be put around the threaded section 22 and the light transmissive protection shell 50 to fix the lampshade 40. Thus the users can easily disassemble the lampshade 40 without touching or moving the LED bulb 61 or other electric components, enabling various choice upon different models of lampshade at users' will and easier cleaning features. On the other hand, different styles of the supporting stand 20 that can combine with other fixtures also make it more decorative.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A refined lampshade structure comprising:
a supporting stand which is hollow and disposed on a base;
a bulb holder disposed on said supporting stand with at least one light bulb thereon connecting to a first electric wire;
a lampshade including a frame and a circular cover, covering said bulb holder;
wherein the bulb holder has a hollow extension tube with a threaded section arranged on top edge thereof, forming a positioning surface;
a LED lighting module engaging with an opening on the top of said extension tube and connecting to a second electric wire from the bottom;
a positioning portion disposed at the center of said frame which has an axial hole that can be engaged on said threaded section to fit said positioning portion and positioning surface; and
a light transmissive protection shell with inside threads at the bottom corresponding to said threaded section to fix it on;
whereby the light transmissive protection shell integrates said LED lighting module with said bulb holder by fixing said lampshade on the extension tube; or it could be disassembled in reverse order to displace said lampshade.

2. The refined lampshade structure as claimed in claim 1, wherein said LED lighting module includes a LED bulb electrically connected to a resistive circuit board that connects to said second electric wire, and a water-proof sheath wrapping up said LED bulb and resistive circuit board, arranged in-between the LED lighting module and the extension tube to fix the structure.

3. The refined lampshade structure as claimed in claim 1, wherein the light tramissive protection shell has a flat bottom at the center with a locking portion bulging up and the inside threads at central thereof, and a cooling opening arranged at the top of said light transmissive protection shell.

4. The refined lampshade structure as claimed in claim 1, wherein the arrangement of the base includes standing vase style, plate style, and inverted T-shaped style, and the supporting stand includes erect tube, A-shaped tube, and curved tube arrangements.

5. The refined lampshade structure as claimed in claim 4, wherein the A-shaped tube arrangement further includes a decoration fixture on said plate style arrangement.
